(19) United States
(12) Patent Application Publication
(10) Pub. No.: US 2002/0083708 A1
(43) Pub. Date: Jul. 4, 2002

(54) Fluid buoyancy generator and its efficiency reform by thermoeffect

(76) Inventors: Buhei Kono, Kyoto (JP); Kazuhito Kono, Kyoto (JP)

Correspondence Address: Buhei Kono, 801 313 Sashimonocho Ebisugawa agaru, Kawaramachi dori Nakagyo, Kyoto, 604-0903, JP

(21) Appl. No.: 10/012,279

(22) Filed: Dec. 1, 2001

Related U.S. Application Data
(60) Provisional application No. 60/255,975, filed on Dec. 14, 2000.
(60) Provisional application No. 60/276,534, filed on Mar. 10, 2001.
(60) Provisional application No. 60/301,957, filed on Jun. 28, 2001.

(51) Int. Cl. F03C 1/00

(52) U.S. Cl. 60/495; 60/496

(57) ABSTRACT

We prove that we can get sustainable clean energy by taking advantage of electric energy created by buoyancy of cylindrical, spherical elliptical drum which has several light density gases in it, put in liquid by fixed axis. We can give outer energy by buoyancy solids in water tube. We can reform it by microwave irradiation thermoeffect. We can create thermoenergy, can transfer electric generating power.

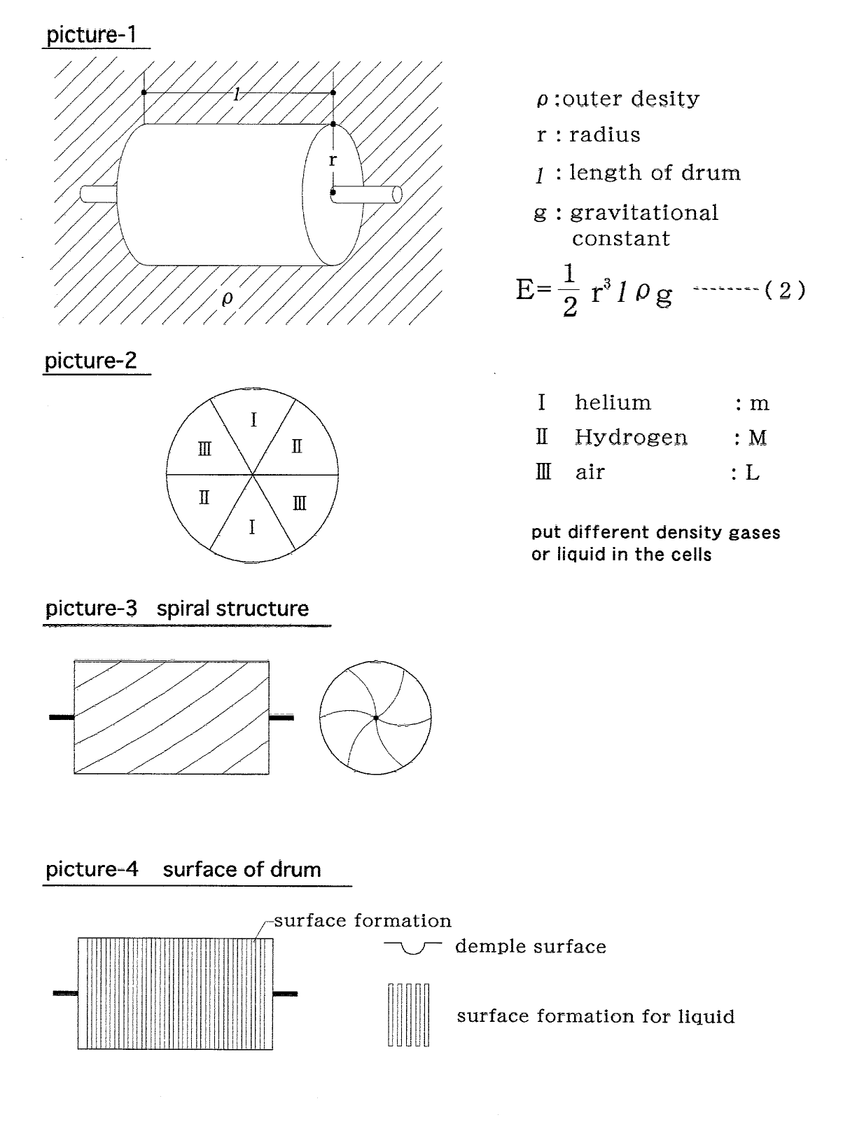

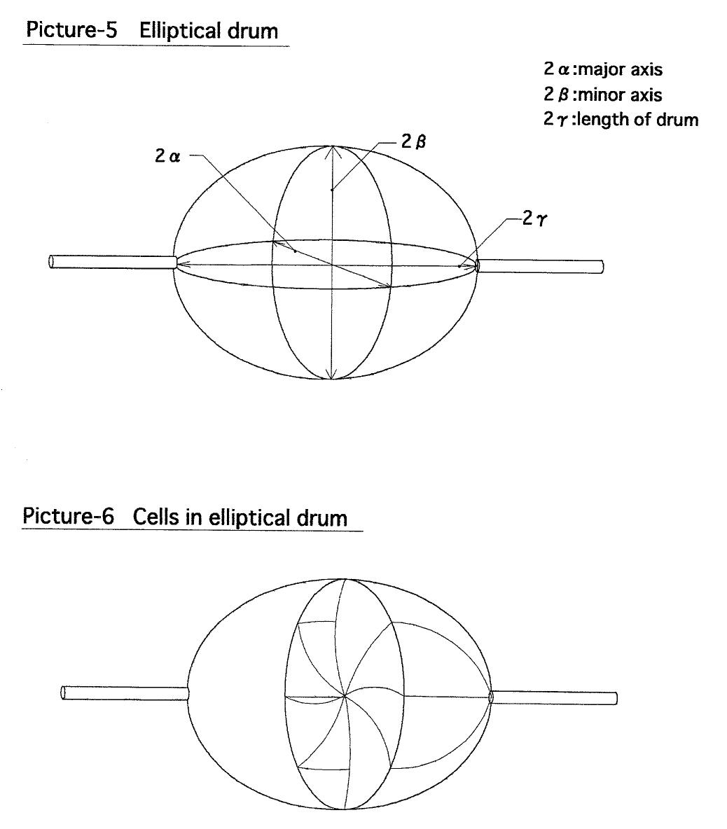

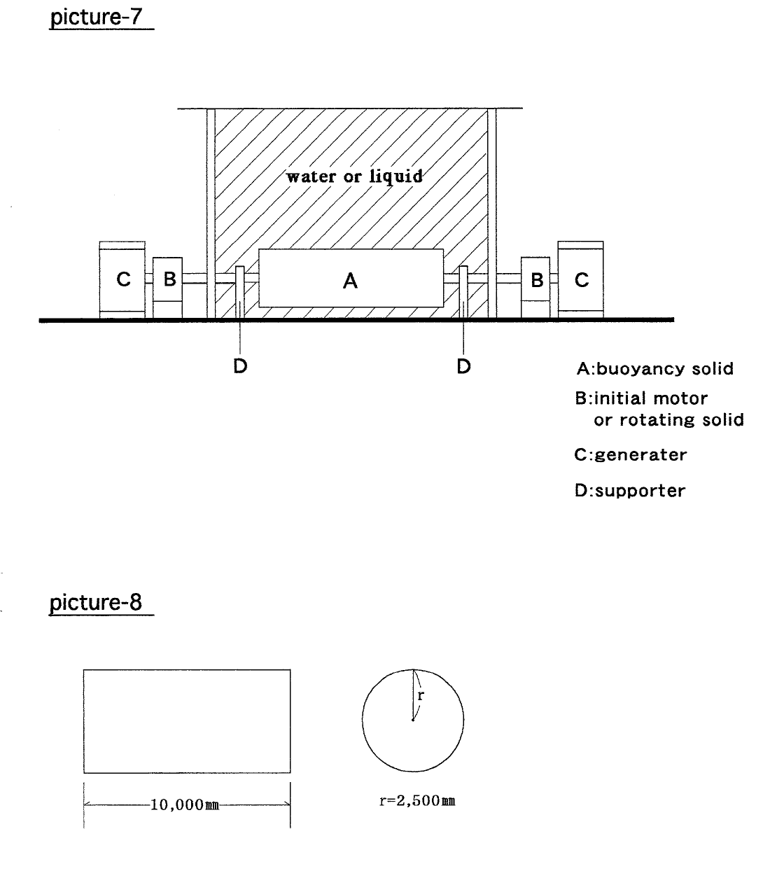

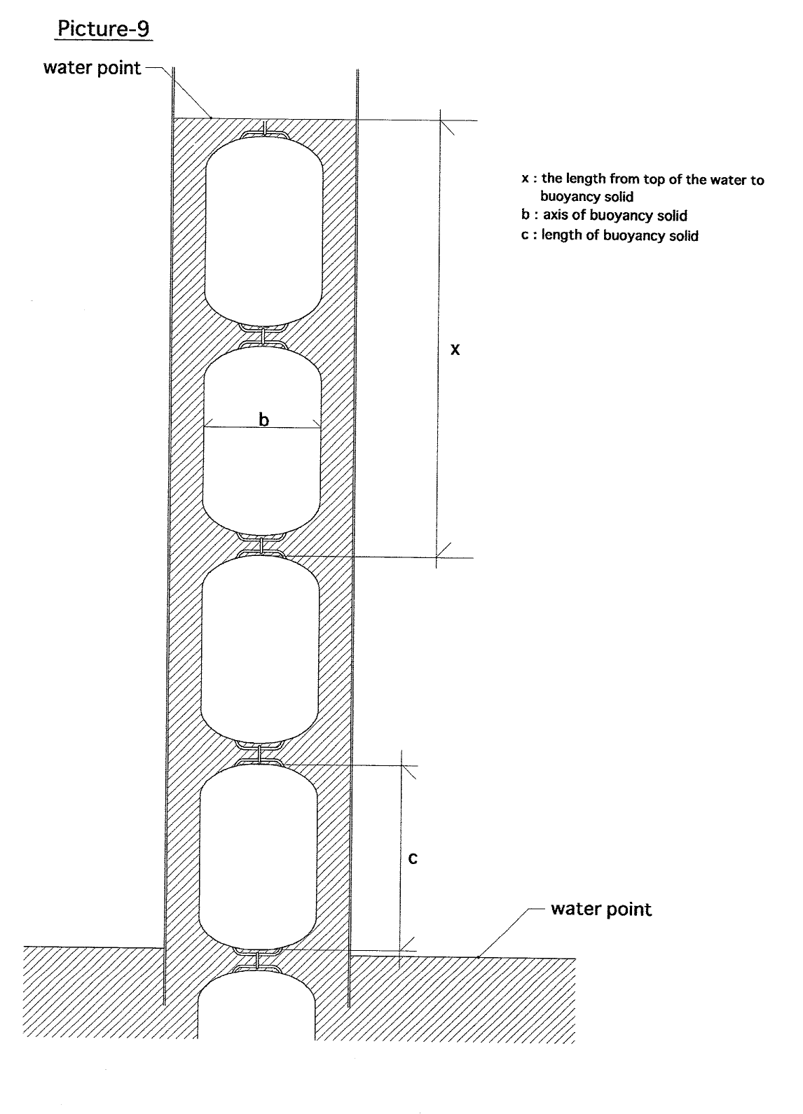

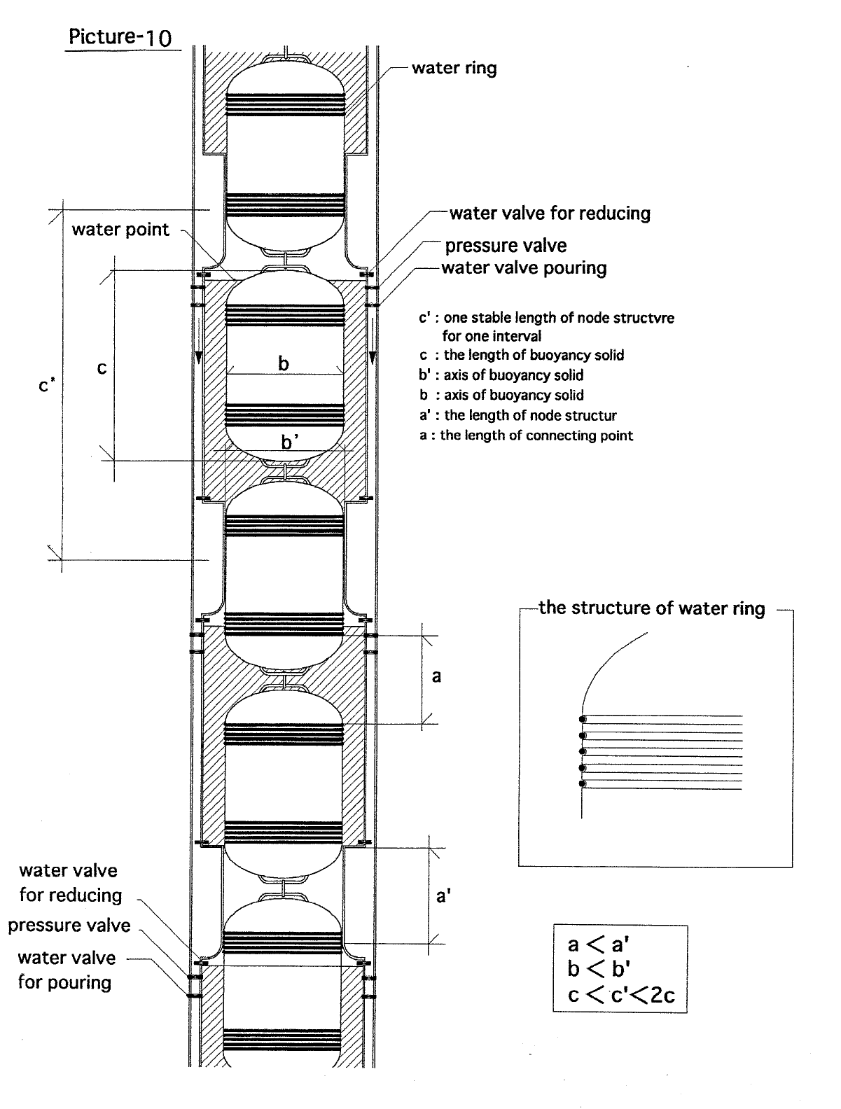

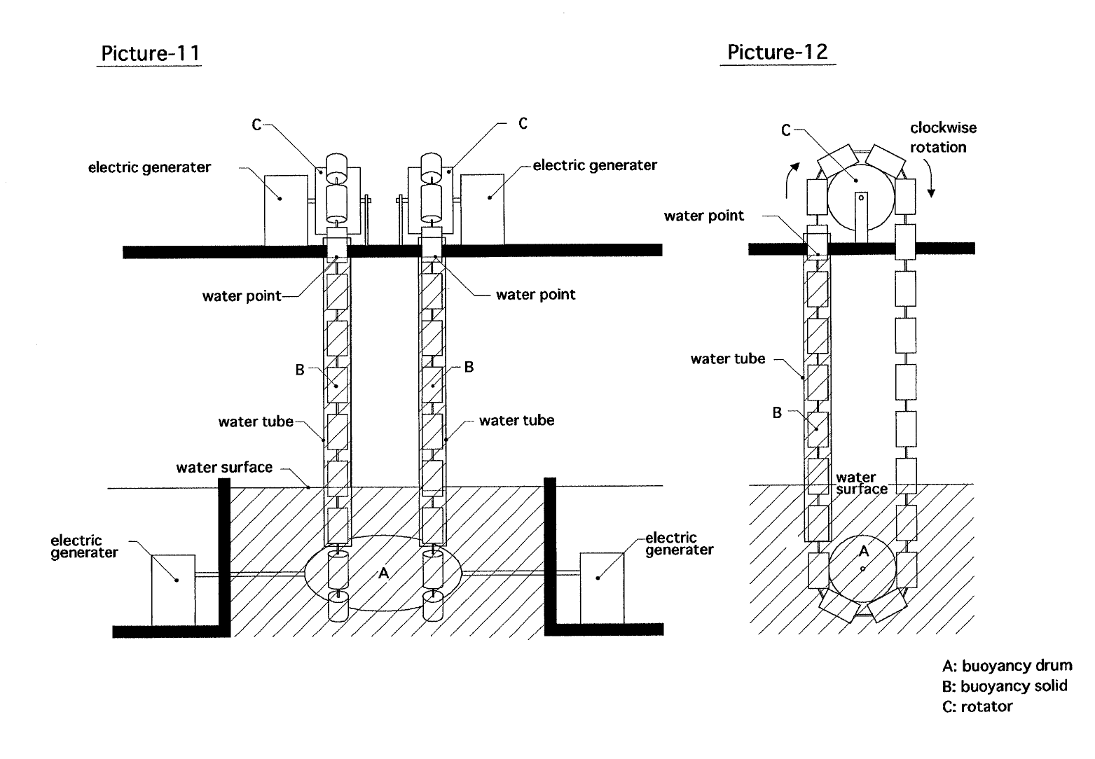

### CROSS REFERENCE

This non provisonal patent application is based on provisional patent application Nos. 60/255,975 date Dec. 14, 2000, 60/276,534 date Mar. 10, 2001, 60/301,957 date Jun. 20, 2001.

### BACKGROUND OF INVENTION

The solar cell and wind generator which are developed as clean energy is influenced by natural environment greatly. The place of setting is limited, the capacity of generating electricity has also research theme. The nuclear generator is pointed out that the controlling its energy has problem,and so inclined to decrease. The electric generator of buoyancy is suggested and several methods are suggested but don't succeed yet. The suggestions about electric generator by buoyancy have structual problem. The buoyancy is the source of energy which is sustained by earth gravity. If the electric generator of buoyancy is succeeded, it isn't influenced by setting can produce stable energy, raise up efficiency and take advantage of electric generator. We create rotational energy by buoyancy. We put on the drum or sphere in liquid such as water, put different density light gases or low density liquid in the cells of drum (example Drawings-A). We get rotational energy. In the cells,we make structure spiral or wing (example reform shape of drum, we set the electric generator by elliptical drum under the surface of water (example Drawings A, picture 5, 6) and run electric generator. The elliptical drum creates more energy than that of cylindrical drum and efficiently increased the energy by running concurrently the buoyancy generator of water tube which has buoyancy solids in the water tube which is reduced pressure and leads to vacuum. (example Drawings A picture-11, 12) In the electric generating system which rotate buoyancy body, we divide the room or cell, in cylindrical, elliptical form of buoyancy solid, incline from 30 degree to 45 degree in the liquid bath and put different density of gases in buoyancy body, we put more than two different kinds of density liquid in bath, we create the rotational energy of buoyancy body by differentiating the different density of gases and liquid. (example Drawings-B)

The spherical, cylindrical, elliptical of buoyancy body, is transferred heat by being irradiated by microwave from the side or bottom. The heat transfer happened domestic gas of buoyancy body and outer liquid. The fluid buoyancy generator's energy is increased and reformed by thermoeffect. (example Drawings-C)

### SUMMARY OF INVENTION

The energy creating of fluid buoyancy generator is that the different density of gases is put into the cell of spherical, cylindrical, elliptical shape of drum or density deviated wood is piled as the cell of the same drum, we put the drum into the heavier density of liquid with axis, the rotational energy of buoyancy happened, we can create the electric generating energy. (example Drawings-A) We can incline drum to from 30 degree to 45 degree, creating energy is effectively increased. We can put on drum in the density deviated liquid, the buoyancy energy is effectively increased. We put drum in the bath corner shifted side from the center of the direction of the left side of rotation, by the compressed hydrodynamical effect, the rotational energy is increased. (example Drawings-B)

From outer, buoyancy solid in water tube can give outer energy to drum. When in the different density of liquid, the drum of different density of gas is put on, and heat is given from outer by microwave irradiation, the thermoeffect of heat transfer occured between different of density of gas and liquid. The energy is created by thermoeffect, effectively transfered rotational energy, electricity generating energy. (example Drawings-B, C)

### DESCRIPTION OF DRAWING

Drawings-A (contents of claims 1)

picture-1 This is the rotating drum, E is rotating energy of buoyancy

picture-2 This is the cells in drum, in each cells, we put on different density of gases.

picture-3 The spiral structure of drum

picture-4 The surface of drum to decrease friction of the liquid. The example of surface of demple

picture-5 elliptical drum major axis; 2α minor axis; 2β length; 2γ

picture-6 The structure of cells in elliptical drum

picture-7 Total system

picture-8 Example of drum of this invention

picture-9 the water tube without nodes

x; the length from top of buoyancy solid to water point

c; the length of buoyancy drum

b; axis of buoyancy drum

picture-10 The water tube with nodes

c′; one stable length of node structure for one interval

c; the length of buoyancy solid

b′; axis of tube

b; axis of buoyancy solid

a′; the length of node structure

a; the length of connecting point

other; water valve (pouring reducing) water ring a′>a, b′>b, 2c>c′>c

picture-11 total design (from front)

picture-12 total design (from side)

Drawings-B (contents of claims 2)

picture-1 total picture, drum in different kinds of density of liquid in bath

picture-2 static status and rotational status, length from the drum to bath corner H<H′

density of the left; ρ density of the right; ρ′

static status ρ=ρ′ rotation status ρ>ρ′

Drawings-C (contents of claims 3)

picture-1 front, buoyancy solid, two kinds of layer of liquid, electric generator, microwave

picture-2 side, microwave tube, two kinds of layer of liquid

picture-3 front, convection of heat and flow, the motion of buoyancy solid

picture-4 side, convection of heat and flow, the motion of buoyancy solid

picturte-5 buoyancy idea, inner hellical structure, quartz, reduced pressure valve.

### DESCRIPTION OF INVENTION

The energy equation of buoyancy is following.

E=ρVg

ρ; density of liquid, V; solid volume, g; gravitational constant

The fundamental style of fluid buoyancy generator is that we will confine the different density of gases in the cells of drum, and put it into the liquid like water, as the result of that we can get sustainable buoyancy. (example Drawings-A) We set the drum in the axis, cells are made surrounding axis, the drum rotate by buoyancy and transform to rotatinal energy. (example Drawings A, picture-2)

The equation of this rotational energy is following

E=r³1ρg/2

r; radius of drum, 1; length of drum, ρ; outer density of liquid, g; gravitational constant.

This is the energy of rotating drum.

This equation proves that buoyancy transforms to rotational energy of drum. The energy is proportional to the third power of the radius of drum and length of drum and outer density. If we connect this rotational drum to electric generator, we can transfer the energy to clean electric energy. If we stabilize and sustain rotational movement, we need to make cells in drum. In the cell, we put on different density of gases, low density liquids, light different density of woods and transform to stable rotation. We set the cell or room the shape of wing or spiral, (example Drawings-A, picture-3) we can get more energy from internal fluid of gas. This equation of energy is following.

E=rρg(inner fluid structural area)/2π

r; radius of drum ρ; outer density of liquid, g; gravitational constant

The internal energy of fluid transfer to the lifting, rotating power by the area of spiral or wing such as air power generator or airplane. The rotation of drum by buoyancy accompanies water friction made by surface device structure. Based on these physical caluculation, to take advantage of buoyancy for electric power, we set the cells in drum in water or oil that is high density, low viscousity and stabilize rotation by structure.

The outer pressure and inner pressure force this drum, needs the stable strength. The structure which can sustain buoyancy is iron concrete or stainless which forbears the pressure of liquid and the pressure of fluid of the rotation.

To raise up the efficiency and ability of creating energy, we use elliptical and stainless style of drum and fixed in the axis, (example Drawings A picture-5, 6) and in the drum, several cells are set, in each cells, different density of liquid is put on. The force of buoyancy works, rotating with fixed axis. It can create the energy.

The equation of energy is following.

E=½πρg(α³γ+αβ²γ)

2α; the major axis of elliptical drum, 2β; minor axis of elliptical drum

2γ; the length of drum

π; circular constant, ρ; the density of liquid, g; gravitational constant

The elliptical drum is more efficient than cylindrical drum. The other efficiency reform of fluid buoyancy generator is that we put drum which has different density of gases in the cell, into more than two kinds of different density of liquid bath, such as, water, tetrachloroethylene C₂Cl₄, density 1.658, or hydrocarbon which is higher density than water, higher boiling point, not soluble in water in inclined from 30 degree to 45 degree direction. (example Drawings-B) The length of radius is gravitational direction. The differentiation of deviation of density makes rotational energy. We can put left side of rotational direction of drum of the corner of liquid bath. When it rotates, left side of density of liquid got higher. The compressible hydrodynamics increase the rotational energy.

(Example Drawings-B, Picture-2)

All energies decay by the friction of rotation and heat loss of rotational friction of shaft and resistance of electric generator.

This equation is following

E=E₀e^{-αt}

E; energy, E₀; initial energy, e; logarithm constant, α=b/G; decay coefficient, b; resistant coefficient, G; total mass, t; time, About the resistivity of the rotational cylindrical drum and elliptical drum, we can compare the following.

The pressure of water over rotating drum

P′=Π−πρU²

Π; The water pressure at infinity, π; circular constant, ρ; the density of liquid, U; the velocity of stream

The maximum of water pressure over rotating elliptical drum

P=Π−3πρU²

P′>P is concluded

The resistivity by water pressure is less in elliptical drum than cylindrical drum. The elliptical drum has more efficiency.

To give force and energy from outside of drum, we put water tube on the surface of water. In the water tube, by the reducing pressure in water tube, we can control the water point. We connect buoyancy solids in water tube and below the water surface, one of two water tubes is reduced the pressure and is led to vacuum. (example Drawings-A, picture-9) We connect the buoyancy solids by the round trips of water tubes and below the water surface. (example Drawings-A, picture-11, 12) The buoyancy solids rotate by buoyancy by water. Below the water surface, we connect the buoyancy solids and rotating drum or elliptical drum, mentioned before and run concurrently and increase the energy. (example Drawings-A, picture-11, 12) We reduce the pressure of water tube and lead to vacuum, the water point of water tube raises up 10.3 m.

The energy of buoyancy solids in the water tube is following

E=10.3NρVg

N; the number of buoyancy solids in raised water

V; the volume of buoyancy solid

ρ; water density g; gravitational constant

In the water tube, the pressure over buoyancy solid and connecting point by water is great, so a lot of negative effect exists. The simple structure of water tube has the limit point of raising water point about 10.3 m. To increase the ability of generating power, we set the nodes in the water tube similiar scale to the radius of buoyancy solids. We divide the portion of water tube, and double the structure, in each nodes, set up water valve, pressure valve, and control water point and energy. We set the water ring structure with buoyancy solids. The water ring structure minimizes the water dropping between nodes, and gives the force of buoyancy, The water ring shuts down the water, reduces the pressure over buoyancy solid, and control the water point. The water ring structure minimizes the friction coefficient between the buoyancy solid and wall of the side of water tube. So the upper limit of buoyancy solid's raising up in water tube. So the upper limit of buoyancy solid's raising up in water tube maximizes, the ability of creating electric generating power increases more. (example Drawings-A, picture-10) In the water tube which water point's raising up is 10.3 m, the length from the top of water to the buoyancy solid is x. The water pressure over buoyancy solid P is following equation.

P=π(b/2)²×ρg

×; circular constant, ρ; water density, g; gravitational constant, b; axis of buoyancy solid (example Drawings-A, picture-9)

The water pressure over buoyancy solid is P and it is big. The strength of structure is needed. If we set the nodes in water tube, the length of node c′, and divide the water in water tube. The total pressure over buoyancy solid PT′ is the following. (example Drawings-A, picture-10)

PT′=π(b/2)²(c′−c)ρg

c′ is shorter than 10.3 m. The pressure over buoyancy solid is small. The pressure over connecting point small. The buoyancy force per buoyancy solid is PV

PV=π(b/2)²cρg

PV>PT′concluded c>c′−c, 2c>c′.

The buoyancy force is greater than the water pressure. When we run concurrently the buoyancy solids in water tube and the rotating elliptical cylindrical drum below the water surface by connecting both of them, both angular velocity should be the same, the power increased effectively. The following equation must be satified

GV/2m=αhu 2γ

G; mass of drum, m; mass of buoyancy solid V; the volume of buoyancy solid.

If the length of the buoyancy solids raising up is L. The energy of solid is following.

EV=LNρVg

N; the number of buoyancy solids in the water

ρ; density of water, g; gravitational constant

The energy EV is added from outer to rotating drum, it can reform efficiency of generator.

The last reform of fluid buoyancy generator is the drum heated by microwave and its thermoeffect reform. In the bath, the buoyancy drum is put on, the buoyancy drum is the shape of elliptical shape. We divide from the center, make hellical shape cell, we put different density of gas in the drum, we pile the different density liquids in the bath, we put the drum on the corner of the left side of rotational drum in the bath, and inclined from 30 degree to 45 degree. We can make complex kinds of energy in the buoyancy solids rotation. The hydrodynamical effect of rotational drum from corner increase energy, create the electric generating energy. We paint activitied carbon or such type material which can be heated by microwave irradiation on the drum activitied carbon or such material which can be heated by thermomolecular effect, the temperature of inner gas of drum raises up, when it is heated by microwave irradiation, the convection between gas and liquid happened. We can get sustainable energy. This energy increases proportional to its temperatutre, can transfer electricity generating work. (example Drawings-C)

If I irradiate microwave to activitied carbon, we can raise more than 1000° C. temperature, go to create energy in its equilibrium temperature. The thermoenergy which is created from transferring from inner drum to outer bath is U in average. The mole of two density of gases n, m, the equilibrium temperature T, If the partition function Z (T)

Z(T)=exp(−3/2n)+exp(−3/2m)

The energy is E, the each gases energy En, Em

ΣEZ(T)=exp(−3/2n)Em+exp(−3/2m)En=exp(−3/2m)3/2mRT+exp(−3/2n)3/2nRT

R: Rydberg constant

The average energy U=ΣEZ(T)/Z(T)

The energy transfer to outer working energy, then can create electricity generating energy. In the inner and outer of buoyancy solid, the gas and liquid of different densities are seperated hellically and toroidally, inner convection occurs by being heated from outside. The medium which has buoyancy deviation which cause rotational energy. If the rotational movement accelerated, the liquid or gas are scrumbled by accumulated layer, the deviation of tensile makes particle and bubble scattered up and down and round on and off. If the inner of buoayncy is heated, temperature is raised up, inner convection raises up, rotational speed is accelerated. (example Drawings C picture-3, 4) If the temperature of heater is 100-200° C., raises up, the fastest motion of particle and bubble occurs, the rotational speed of buoyancy is accelerated. If the rotational energy is connected electric generator, energy generated by this system can be got more times of power than the power, initially micowave consumed. In this system, we select the two kinds of liquid in bath for example such as, water 1.0, tetrachloroethylene C₂Cl₄, density 1.658 at 20° C., or hydrocarbon, which is high temperature, high boiling point, not soluble in water, the pressure valve is set in head. The reduced pressure valve is safety valve for which raises up inner pressure valve. In the bottom side of buoyancy body, the quartz is fixed in window. In the bottom, activitied carbon is painted. The microwave is energy source, induced from microwave tube, closed so that water can't permeat. The mouth of microwave tube is shut down by quarts which makes irradiation possible. Guide is attached to the inner bath not to be scattered during irradiation. (example Drawings-C)

1. The cylindrical, spherical, elliptical drum which has several kinds of lighter density of gases or liquid in its cells is set in the axis. We can make it rotate by buoyancy, so that we put drum in heavier density liquid and connect electric generator, generate electricity. Previouly mentioned drum which has empty room or cells in the drum. There are axis central radial cell structure. In the cells we can put light density gas or liquid or wood. If we can make cell structure spiral or hellical, we can make fluid dynamical force to drum, we can increase energy efficiency. We set the water tube on the surface of water, beneath the water previously mentioned drum exists. We can make two water tube stood vertically on the water surface, we reduce the pressure of one side of water tube, make it vacuum, so water point raises up we can put buoyancy solids in water tube, it can round travel water tube and beneath the water, we can concurrently connect this buoyancy solids and drum, efficiently increase the energy from outer force. (example Drawings-A)

2. In the elliptical, spherical, cylindrical drum, we put different kinds of light density gas or liquid in its cells. We put the drum in the bath which has more than two kinds of heavy density liquids such as water, or liquid which is higher density than water, high boiling temperature, not soluble in water such as tetrachloroethylene C₂Cl₄, density 1.658, or hydrocarbon. The drum rotate by the differentiation of deviation of density of gas and liquid. If the drum is put on the left corner of the direction of rotation in the bath, when it rotates, density of liquid got higher in left corner of direction. The compressed hydrodynamical effect makes rotational energy increase. We can effectively increase electric generating energy. (example Drawings-B)

3. We put the drum which has radial cells which has different kinds of light density gas and liquid, in the two kinds of different density of liquid in the bath such as, water, tetrachloroethylene C₂Cl₄, density 1.658, or doesn't scatter microwave, heat transfer happened between gas and liquid, and internal energy increased. We can effectively increase energy by thermoeffect, increase electric generating energy effectively. (Drawings-C)
